(19) United States
(12) Patent Application Publication
(10) Pub. No.: US 2018/0216986 A1
(43) Pub. Date: Aug. 2, 2018

(54) Electronic Assembly with Integral Damping

(71) Applicant: Texas LFP, LLC, Dallas, TX (US)

(72) Inventors: Chester Roy Wildey, Euless, TX (US); Robert E. Hrncir, Irving, TX (US); Luis Alberto Garcia, Cuautitlan Izcalli (MX)

(21) Appl. No.: 15/421,773

(22) Filed: Feb. 1, 2017

(51) Int. Cl. G01F 23/30; G01F 23/62

(52) U.S. Cl. CPC G01F 23/303; G01F 23/62

(57) ABSTRACT

A transducer for determining the level of liquid within a container includes a mounting head for connection to the container; a senor tube extending from the mounting head; a substrate located in the sensor tube; at least one sensor positioned on the substrate for sensing a level of liquid within the container; and a float constrained to move along the sensor tube. The float has an actuator for changing an electrical state of the sensor to thereby indicate liquid level. At least one damping section having at least one damping beam integrally formed with the substrate is normally in contact with a surface associated with the sensor tube and is movable toward and away from the substrate to dampen forces acting on the transducer and thus on the at least one sensor. An electronic assembly with integral damping sections is also described.

### BACKGROUND OF THE INVENTION

This invention relates to damping mechanisms for electronics, and more particularly to integrally formed damping areas on a circuit board, such as a printed circuit board (PCB), used in harsh environments where electronics connected to the PCB may be subjected to vibration or acceleration forces transmitted from motorized vehicles, stationary devices, industrial equipment, and so on.

PCB's and the like, including electronic components connected thereto, are found in many devices that may be intermittently or constantly exposed to shock, vibration, or other forces based on acceleration and/or deceleration, centrifugal forces, and so on, that may exceed the design limits of the PCB's and/or the components connected thereto. For example, a relatively small hand-held device, such as a smartphone or the like, may be dropped onto a hard surface and thus be subjected to acceleration forces as the instrument falls, and abrupt deceleration forces upon impact of the device with the surface. Such a scenario may also create additional oscillations as the device continues to bounce along the surface in most likely random orientations, thereby introducing corresponding centrifugal forces. One or more of the resultant forces may cause propagating cracks in the PCB which may interfere with conductive traces associated therewith, as well as electronic component failure, breakage, and/or separation from the PCB. Likewise, relatively large vibrational forces created by stationary equipment and vehicles used for transportation, construction, farming, aviation, and marine industries can have negative effects on PCB's and related electronic components when resultant forces exceed the strength of PCB and electronic component materials as well as the adhesion strength between such materials.

Some electronic components associated with the above-mentioned industries can be relatively fragile in nature, and therefore great care must be used when designing equipment employing such components. For example, transducers for measuring liquid level are often used in vehicles, industrial equipment, as well as other mobile and stationary systems. The electrical output of such transducers varies in response to a change in the liquid level being measured and is typically in the form of a change in resistance, capacitance, current flow, magnetic field, and so on. These types of transducers may include PCB's or other platforms with variable capacitors or resistors, optical components, Hall-effect sensors, reed switch arrays, and so on.

For liquid level transducers employing reed switches, a plurality of reed switches are usually arranged in series with a plurality of resistors along the length of a PCB. The reed switches are normally responsive to the presence and absence of a magnetic field for opening and/or closing the switch. A float rides along the surface of the liquid to be measured and is constrained to move in a linear direction along the PCB. The float usually includes an embedded magnet to trip one of the reed switches as the float moves in response to a change in liquid level in the tank. Thus, the resistance of the circuit, which is indicative of liquid level, depends on the position of the float and the particular reed switch that has been tripped.

Although improvements to reed switches have been made over the years, they still suffer several drawbacks, the most prevalent of which may be their fragile nature as they are typically constructed of a sealed glass housing and two contacts positioned on ferrous metal reeds within the housing. Both the housing material and the small size of the contacts and reeds are subjected to breakage when sufficient vibrational and/or impact forces are applied. Once breakage of one or more reed switches occurs, the transducer may no longer be functional and thus may need replacement.

In addition, prior art liquid level transducers that include a mounting head and an elongate sensor probe, such as a reed switch probe, resistor probe, capacitor probe, and so on, are often difficult and time-consuming to assemble due to the number of individual components and the fastening means associated with each component.

It would therefore be desirable to overcome at least some of the disadvantages associated with electronic assemblies including prior art reed switch-type liquid level transducers. It would also be desirable to provide an electronic assembly, including a liquid level transducer, that is easier to assemble and has relatively fewer parts.

### SUMMARY OF THE INVENTION

In accordance with one aspect of the invention, a transducer for determining the level of liquid within a container includes a mounting head adapted for connection to the container; a sensor tube extending from the mounting head; a substrate located in the sensor tube; at least one sensor positioned on the substrate for sensing a level of liquid within the container; and at least one damping section having at least one damping beam integrally formed with the substrate and partially separated therefrom by a slot formed between the at least one damping beam and the substrate. The at least one damping beam is normally in contact with a surface associated with the sensor tube and is movable toward and away from the substrate to dampen forces acting on the transducer and thus on the at least one sensor.

In accordance with a further aspect of the invention, an electronic assembly includes a substrate for receiving at least one electronic component; at least one damping section integrally formed with the substrate and including at least one slot formed in the substrate and at least one damping beam partially separated from the substrate by the at least one slot. The at least one damping beam is adapted to flex when the electronic assembly is exposed to outside forces to thereby dampen resultant forces acting on the substrate.

In accordance with yet another aspect of the invention, a method of damping an electronic assembly includes providing a substrate with at least one electrical property; forming a slot in the substrate to define at least a portion of a damping beam integrally connected to the substrate; exposing the electronic assembly to an outside force; and flexing the damping beam toward and away from the substrate to thereby dampen a resultant force on the substrate.

Other aspects of the invention will become evident upon considering the following detailed description of the preferred embodiments of the invention in conjunction with the accompanying drawings.

### BRIEF DESCRIPTION OF THE DRAWINGS

The following detailed description of the preferred embodiments of the present invention will be best understood when considered in conjunction with the accompanying drawings, wherein like designations denote like elements throughout the drawings, and wherein:

FIG. 1 is a top isometric view of a liquid level transducer in accordance an exemplary embodiment of the invention;

FIG. 2 is a longitudinal sectional view of the liquid level transducer taken along line 2-2 of FIG. 1 and showing an exemplary electronic assembly in accordance with the invention with portions thereof being enlarged to show details of the invention for dampening the electronic assembly when subjected to external forces associated with impact, vibration and the like;

FIG. 3 is a front elevational view of a printed circuit board (PCB) in accordance with an exemplary embodiment of the invention with portions thereof being enlarged to show details of the damping system of the invention;

FIG. 4 is a chart illustrating differences in impact forces between a prior art PCB and the PCB with integral damping members in accordance with the invention;

FIG. 5 is a top isometric view of an electronic assembly with integral damping features in accordance with a further embodiment of the invention;

FIG. 6 is a top isometric exploded view thereof;

FIG. 7 is a top plan view of a PCB with integral damping features in accordance with the invention; and

FIG. 8 is a sectional view of the electronic assembly taken along line 8-8 of FIG. 5.

It is noted that the drawings are intended to depict only exemplary embodiments of the invention and therefore should not be considered as limiting the scope thereof. It is further noted that the drawings are not necessarily to scale. The invention will now be described in greater detail with reference to the accompanying drawings.

### DETAILED DESCRIPTION OF THE INVENTION

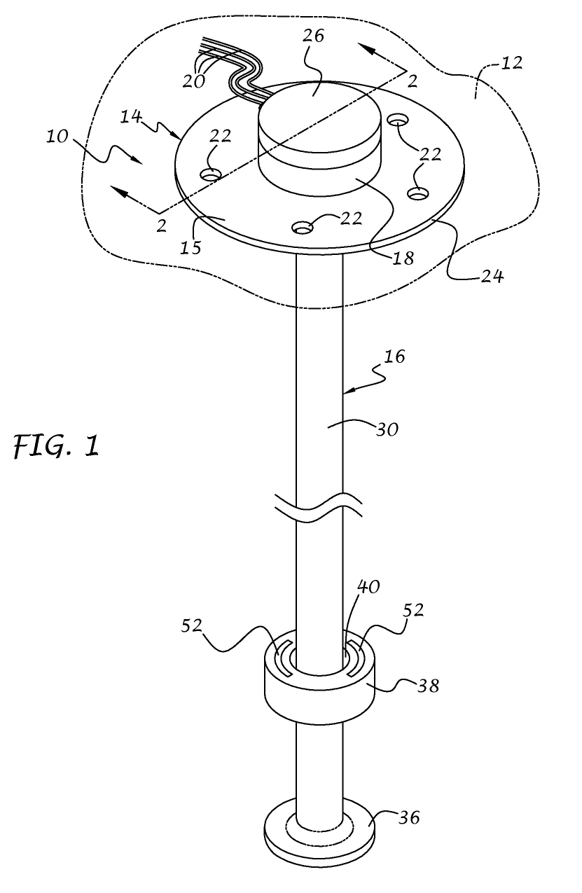

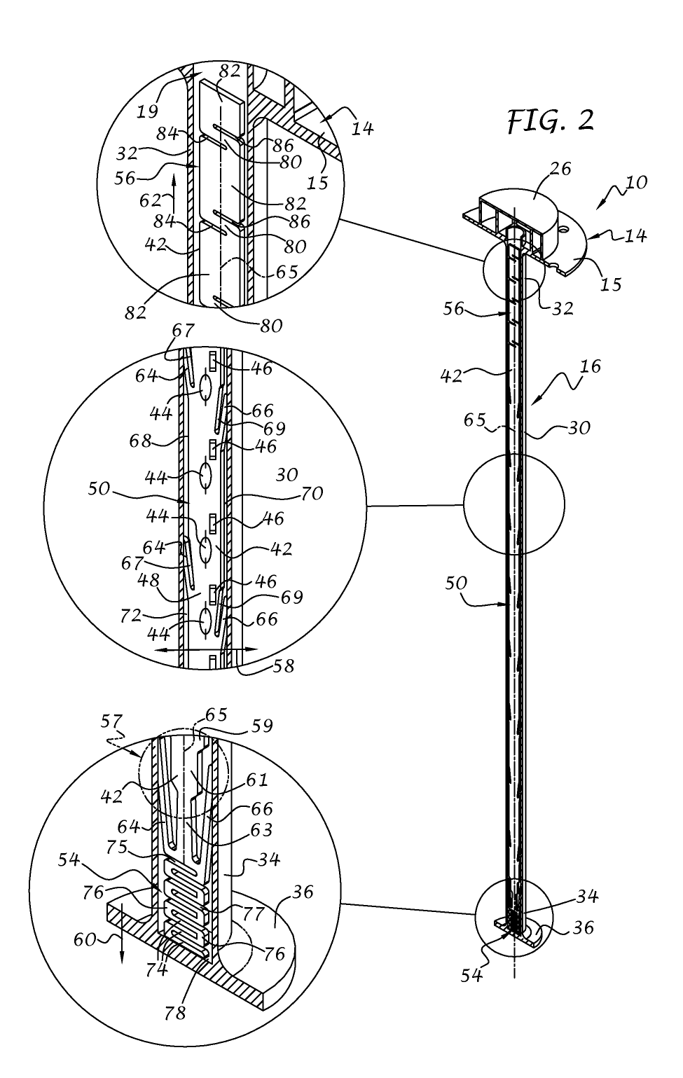

Referring now to the drawings, and to FIGS. 1 and 2 in particular, a liquid level transducer 10 in accordance with an exemplary embodiment of the present invention is illustrated. The liquid level transducer 10 preferably extends into a container 12 (shown in phantom line in FIG. 1), such as a fuel tank, oil reservoir, radiator, brake fluid chamber, or any other container for holding and/or transporting a liquid (not shown) where it is desirous to determine the level of liquid within the container. The transducer 10 preferably includes a mounting head 14 for connection to the container 12 and a sensor assembly 16 extending therefrom. Although the transducer 10 is shown as being oriented in a vertical direction, it will be understood that the transducer 10 can be oriented in a horizontal direction or any other suitable angle or orientation, without departing from the spirit and scope of the invention, such angle or orientation being dependent at least partially upon space constraints as dictated by the structure of the vehicle, machine, etc., with respect to the container 12 and/or the particular shape of the container.

The mounting head 14 preferably includes a mounting flange 15 extending radially outwardly from an annular side wall 18 that forms a hollow interior 19 (FIG. 2) for housing electronics and electrical wires 20 (FIG. 1) associated with the sensor assembly 16 to thereby power the sensor assembly and communicate signals associated with a liquid level condition within the container 12. The wires 20 extend from the mounting head 14 for connection to a remote location which can include further electronics for processing and communicating the liquid level condition of the container. The mounting head 14 can be formed as a unitary structure through injection molding, but may alternatively be formed by machining, die-casting, or other known forming means. The mounting flange 15 is disk-shaped and includes a plurality of mounting holes 22 that extend axially through the mounting flange and in proximity to its outer peripheral edge 24. The mounting holes 22 are adapted to receive threaded studs (not shown) associated with a tank or other container in a well-known manner. A cover or cap 26 is connected to the annular side wall 18, preferably in a snap-fit engagement, to retain the cap 26 on the mounting head 14 and enclose the hollow interior 18. A sealing arrangement (not shown) may be provided between the side wall 118 and the cap 26 so that the hollow interior 18 is isolated from the environment outside of the container. A gasket (not shown) can also be provided between the mounting flange 15 and the container for sealing the opening (not shown) in the container through which the sensor assembly 16 of the transducer 10 extends. Further details of an exemplary suitable mounting head can be found in U.S. Pat. No. 8,567,244 issued on Oct. 29, 2013, the subject matter of which is hereby incorporated by reference.

It will be understood that the mounting head 14 is not limited to a flange mounting arrangement as shown, as other means for mounting the liquid level transducer 10 to a tank or other container can be used, including NPT type threads, clamping, welding, and so on, without departing from the spirit and scope of the invention. Moreover, the mounting head 14 can be constructed of a molded material, such as plastic, through injection molding or other techniques. However it will be understood that the mounting head 14 can be constructed of metal, composites, ceramics, combinations thereof; or any other suitable material.

As best shown in FIG. 2, the sensor assembly 16 preferably senses liquid level in a linear direction and, in accordance with one preferred embodiment of the invention, includes an outer sensor guide tube 30 with an upper end 32 that connects with the mounting head 14 and a lower end 34 that terminates at a lower support member 36. A magnetic float 38 is preferably cylindrically-shaped and includes a central bore 40 that is sized to receive the sensor guide tube 30 so that the float slides freely therealong in response to changes in liquid level within the container 12. The lower support member 36 serves to both seal the guide tube 30 from the contents of the container 12 and provide a lower stop for the float 38 to rest on when the container is in an empty condition, e.g. when a level of liquid within the container is below the lower-most position of the float. The sensor tube 30 is preferably constructed of non-magnetic materials such as plastic, aluminum, composites such as carbon fiber, fiberglass, and so on, as well as other materials or combinations thereof.

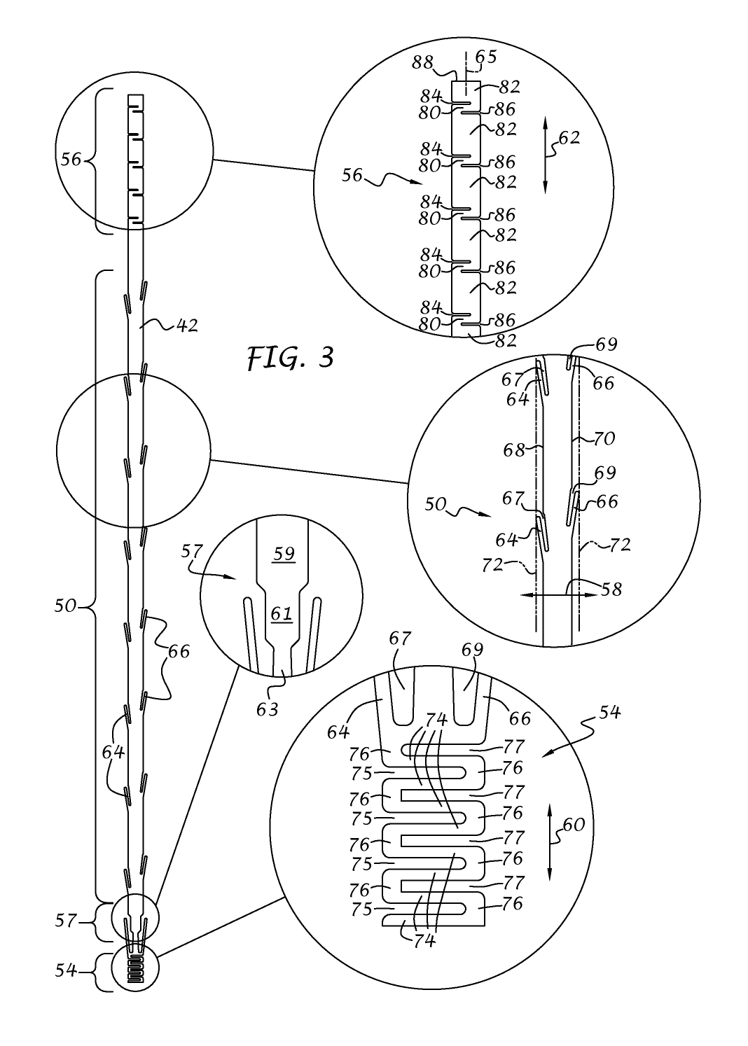

Referring now to FIGS. 2 and 3, the sensor assembly 16 preferably includes an elongate, relatively thin substrate 42 located within the sensor tube 30. The substrate 42 extends along a substantial length of the sensor tube 30 and extends substantially across its width, diameter or cross-dimension to provide enhanced damping results, as will be described in greater detail below. The substrate 42 preferably comprises a printed circuit board (PCB) and can be constructed of conventional materials, including but not limited to, the phenolic series of materials or laminates such as FR-1, FR-2, FR-3, FR-4, FR-5, and FR-6; the woven glass and epoxy series such as G-10, and G-11; the cotton paper and epoxy series such as CEM-1, CEM-2, CEM-3, CEM-4, CEM-5; as well as PTFE, ceramic-filled PTFE, RF-35 (a ceramic-filled PTFE with fiberglass reinforcement); and flexible substrates such as polyamide foils and polyimide-fluoropolymer composite foils. However, it is anticipated that other unconventional materials can be used, such as printed thermally conductive ABS or PLA sheets or objects, as well as conductive traces formed on any insulative material that can ultimately define an electronic circuit either alone or when combined with electronic components.

The substrate 42, embodied as a PCB, can include traces, ground planes, and so on, for connecting various electronic components, such components being selected based on their suitability for intended functions. In this particular exemplary embodiment, the PCB 42 is populated with a plurality of normally-open reed switches 44 (FIG. 2) in series with a plurality of corresponding resistors 46. The reed switches 44 and resistors 46 are preferably located on a first surface 48 of the PCB 42 and along the length of a first section 50 associated with the PCB 42 for sensing liquid level and damping the substrate 42 in a lateral direction, as will be described in greater detail below. If desired, reed switches and resistors can be mounted on an opposite side of the PCB 42 (not shown) with a skewed arrangement to obtain greater resolution when needed. The reed switches 44 are normally open to create a single closed circuit with a single resistor of a predetermined value to thereby indicate a particular liquid level. Other reed switches are associated with other values of resistors so that closure of a particular reed switch in response to the presence of a magnetic field signals a particular liquid level within the container. It will be understood that normally closed reed switches can alternatively be used without departing from the spirit and scope of the invention.

The reed switches 44 can be oriented at an acute angle with respect to a longitudinal axis of the sensor tube 30, as better switching performance has been achieved in this manner. However, the reed switches can be in any suitable orientation as long as they are responsive to the magnetic float 28 for creating a liquid level signal, in conjunction with the resistors 42 as previously described, as the float 28 rides along the outer sensor guide tube 20 in response to a change in liquid level within the container.

Although a representative number of reed switches and spacing therebetween are shown within the first section 50 of the substrate 42 in FIG.2, it will be understood that more or less reed switches can be provided at equal or varying spacing without departing from the spirit and scope of the invention. In instances where it may be more desirable to know how fast the container is approaching a full level during a filling operation to cut off a filling pump or the like, more sensors can be positioned closer together at the top of the first section 50 of the substrate 42 so that the liquid level can be more precisely and quickly determined at the top of the container. To that end, it may be desirable to reduce the number of sensors along the substrate 42. Likewise, in the event where it may be more important to determine how fast the container is approaching empty, it will be understood that more sensors can be located at the lower end of the first section 50 of the substrate 42, and thus the lower end of the container.

Moreover, although a reed switch-type arrangement on the PCB 42 has been shown and described, it will be understood that the present invention is not limited thereto. Other sensor(s) can be used without departing from the spirit and scope of the invention, including, but not limited to, hall-effect devices spaced at longer intervals along the substrate 42, other magnetic sensing probe technologies such as solid state magnetic flux field sensors (MR or GMR) magnetostrictive probe devices, solid state Micro-Electro-Mechanical Systems (MEMS), magnetic switches, as well as nonmagnetic sensing technologies such as optical sensors, mechanical switches, other electrical or mechanical position sensors, capacitance, and so on.

When Hall-effect, MR or GMR sensors are used for example, a single sensor can be placed at a single location or at a plurality of locations along the substrate 42. For instance, the single sensor can be placed at or near the top of the substrate 42 for detecting when the container is approaching a full condition. In addition or alternatively, a sensor can be placed on the substrate 42 at approximately a middle portion thereof for determining when the liquid in the container reaches the half-way point. Likewise, a sensor can be positioned on the substrate 42 at or near the bottom of the container for determining when the container is approaching an empty condition and/or when a filling operation has commenced.

The float 38 preferably includes a cylindrical body 44 to match the cylindrical shape of the sensor tube 30 and is constructed of a rigid material, such as closed-cell nitrile material, rubber, plastics, and so on. However, it will be understood that the shapes of the float, sensor tube 30, the mounting head assembly, and so on, are given by way of example only, as other suitable shapes, such as square, triangular, and so on, can be used without departing from the spirit and scope of the invention.

As best shown in FIG. 1, magnets 52 are located within the float 38 and are oriented such that their magnetic flux lines of force are directed toward the center of the sensor tube 30 for changing the electrical state of the reed switches 44 (or other magnetically responsive sensors) as the float 38 slides up and down the sensor tube 30 in response to a change in liquid level within the container 12.

Referring again to FIGS. 2 and 3, the substrate 42 is divided into the first damping and sensing section 50, a second damping section 54, a third damping section 56, and a fourth damping section 57. For purposes of simplifying the description, the term “damping” and its derivatives as may be used herein, refer to one or more different mechanisms or modes by which a shock wave may be propagated, reduced, and/or dispersed through the substrate. For example, the term “damping” can include shock wave propagation, reflection, division, dispersion, reduction of amplitude either immediately or over time, as well as other modes for controlling and/or minimizing the effects of one or more shock waves on the substrate 42 as well as any components connected thereto. Accordingly, each damping section has different properties for accomplishing different damping or shockwave control functions. For example, the first damping section 50 creates a damping effect of the substrate 42 in opposing lateral directions, as denoted by double direction arrow 58 in FIGS. 2 and 3. Likewise, the second and third damping sections causes damping of the substrate 42 in opposing longitudinal directions as denoted by arrows 60 and 62, respectively. The fourth damping section 57, which is just above the second damping section 54, has reduced width portions to disperse the reflected shock wave over time, thus decreasing the amplitude of the shock wave at any particular time.

The first damping section 50 preferably includes a first set of damping members or beams 64 that are integrally formed with the substrate 42 and partially separated therefrom by a first slot 67 formed in the substrate so that the first beams 64 cantilever upwardly and slightly outwardly from a first longitudinal edge 68, which as viewed in FIG. 3 represents the left edge of the substrate 42. Likewise, the first damping section 50 includes a second set of damping members or beams 66 that are integrally formed with the substrate 42 and partially separated therefrom by a second slot 69 formed in the substrate so that the second beams 66 cantilever upwardly and slightly outwardly from a second longitudinal edge 70, which as viewed in FIG. 3 represents the right edge of the substrate 42. The first and second slots 67 and 69, and thus the first and second respective beams 64 and 66, extend at an acute angle with respect to a longitudinal axis 65 (FIG. 2) of the substrate 42. However, it will be understood that the damping members can extend horizontally and/or downwardly, begin with an upward, downward, or horizontal direction then curve downwardly and/or upwardly, as well as a variety of other configurations, without departing from the spirit and scope of the invention so long as the beams 64 and 66 dampen movement in lateral directions, which are generally perpendicular to the longitudinal axis 65.

The damping beams 64 and 66 are in normal contact against opposite sides of the inner surface 72 (FIG. 2) of the sensor tube 30, while the integral nature of the damping beams 64 and 66 with the substrate 42 and their relatively thin cross-sectional profile create opposing biasing forces of the first damping beams 64 and second damping beams 66 against opposite sides of the inner surface 72 of the sensor tube 30. This arrangement helps to center the substrate 42 within the sensor tube 30 and also facilitates insertion of the substrate into the sensor tube during assembly, as the damping beams 64 and 66 will tend to flex inwardly toward their respective edges 68 and 70, respectively, thereby at least partially closing the slots 67 and 69, when the substrate 42 is inserted into the sensor tube. The beams 64 and 66 are also somewhat resilient within the elastic range of movement, due to the relatively thin cross sectional area of the beams at the interface between the substrate 42 and the beams.

In use, lateral impact or vibrational forces are transmitted to the liquid level transducer 10, either directly or indirectly, through structure connected to the liquid level transducer, such structure forming part of a machine or the like. Such lateral forces may occur for example when the structure or transducer hits or is hit by a solid object, starts suddenly with a jerk or stops suddenly, as well as other events that may cause lateral forces to act on the transducer 10. These transmitted forces are dampened by the beams 64 and 66 as they flex toward and away from their respective edges 68 and 70, to thereby dampen vibrational movement of the substrate 42 in the lateral direction as represented by arrow 58 (FIG. 3), and protect any electronic components, including the relatively fragile reed switches 44, that may be mounted on or otherwise connected to the substrate 42.

The second damping section 54 also includes a plurality of damping members or beams 74 integrally formed with the substrate 42 and connected to each other in cantilever fashion via integral links 76 that alternately extend between adjacent ends of damping members 74 separated by first slots 75 extending from left to right in FIG. 3 and second slots 77 extending from right to left, to thereby form a convoluted damping structure 72. The damping members 74 extend generally parallel to each other and perpendicular to the integral links 76, which in turn extend generally parallel with the longitudinal axis 65 of the substrate 42. In this manner, longitudinal forces acting on the damping structure 72 are concentrated in the integral links 76. However, it will be understood that both the links 76 and the damping members 74 can be oriented at various angles to vary the location and intensity of stress within the damping structure 72.

The integral nature of the damping beams 74 and links 76 with the substrate 42 create an opposing biasing force when shock or vibration is transmitted to the lower end of the liquid level transducer 10 in a longitudinal direction, e.g. in a direction parallel with the longitudinal axis 65. The damping structure 72 normally rests against an upper surface 78 (FIG. 2) of the lower support member 36. When shock or vibration in the longitudinal direction occurs, such as when the transducer 10 and/or the structure to which it is attached is dropped, or is exposed to vibrational frequencies often associated with motorized vehicles, the damping beams 74 move toward and away each other and respectively narrow and expand the slots 75 and 77 to thereby significantly dampen the resultant forces acting on the substrate 42 and its attached components.

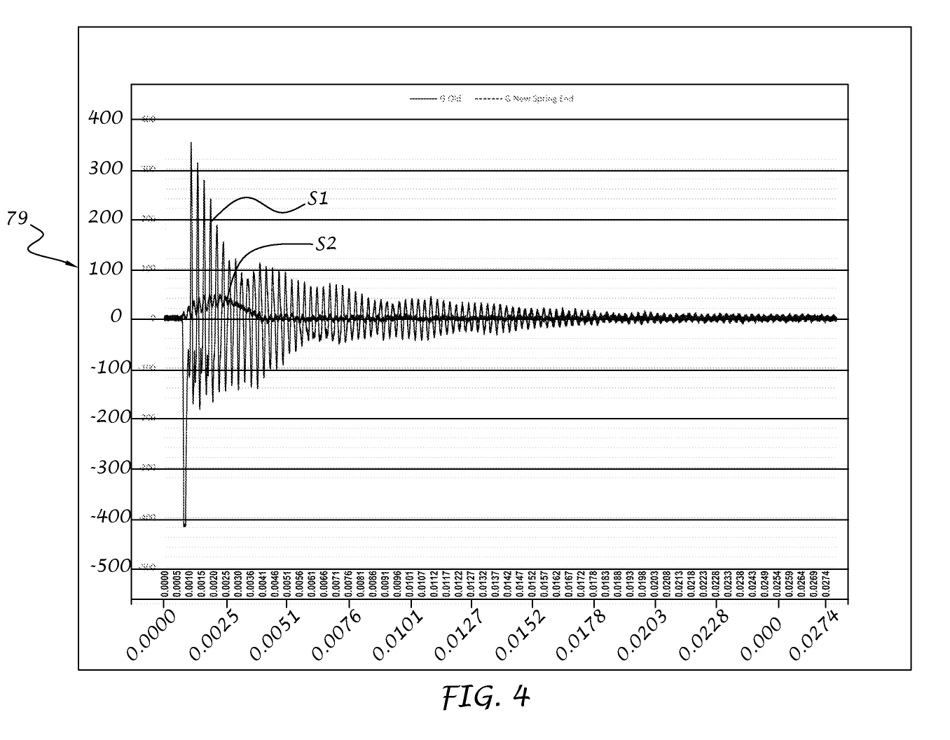

As shown in FIG. 4, a chart 79 representing the vibrational response of a predetermined drop of first and second substrates is illustrated. The first substrate comprised a regular PCB with an attached accelerometer, i.e. the PCB did not have any integral damping structure. The second substrate comprised a PCB of similar size with an attached accelerometer and the integrally formed damping structure 72. The chart 79 shows acceleration of each PCB over time, measured in ten thousandths of a second, upon vertical impact of the PCB's with a horizontal surface. As shown, the first PCB without damping structure exhibited a relatively large diminishing sinusoidal response as shown by the generally sinusoidal-shaped line S1. In contrast, the second PCB with the damping structure 72 exhibited a relatively small diminishing sinusoidal-shaped line S2. From these results it is clear that the integrally formed damping structure of the second PCB produced far superior results over the first PCB without the integral damping structure and therefore components mounted on or otherwise connected to the second PCB will tend to have a longer service life than components associated with the first PCB. With the integrally formed damping structure, no additional material costs are added to the liquid level transducer 10, and in fact manufacturing costs can be lowered with the elimination of prior art potting material commonly used to protect reed switch arrays.

Referring again to FIGS. 2 and 3, the third damping section 56 is somewhat similar to the second damping section 54, and includes a plurality of cantilevered damping members or beams 80 and cantilevered substrate areas 82 located between the damping members 80. The damping members 80 and substrate areas 82 are integrally formed with the substrate 42 and are separated from each other by a first slot 84 extending from the edge 68 of the substrate and a second slot 86 extending from the edge 70 in the opposite direction. The height of the first slot is different from the height of the second slot to thereby define the height of the damping member 80. The lengths of each slot 84, 86 also define the length of each damping member 80. Although the height and width of each damping member and each substrate area are shown as being equal, it will be understood that the dimensions can greatly vary for a particular damping effect or capacity.

The substrate areas 82, which also serve to dampen the substrate 42, can be populated with electronic components, connectors, and so on. Likewise, the damping beams 80 can carry electrical traces, ground planes, and so on, for transferring signals and power through the third damping section 56.

The integral nature of the damping beams 80 and areas 82 with the substrate 42 create an opposing biasing force when shock or vibration is transmitted to the upper end of the liquid level transducer 10. The upper end 88 of the substrate 42 can be restrained by additional structure (not shown) associated with the mounting head 14 or sensor tube 30. The upper end 88 can alternatively be left free of restraint to accommodate and provide a dampening effect for cable connectors (not shown) or other components located at the upper end of the substrate 42. The damping members 80 extend generally parallel to each other and perpendicular to the axis 65 to dampen longitudinal forces acting on the substrate 42. However, it will be understood that the slots, and thus the damping members 80, can be oriented at various angles to vary the location and intensity of stress within the third damping section 56.

The fourth damping section 57 includes narrowing neck portions beginning at the lower end of the PCB as designated by numeral 59, then continuing with a pair of distinct narrow neck portions 61 and 63 in a downward direction, or as the PCB approaches the second damping section 54. The decreasing widths of the narrowing neck portions 61 and 63 serve to disperse the reflected shock wave over time, thus decreasing the amplitude of the shock wave at any particular time. This is accomplished via reflecting part of the shock wave propagating from top to bottom of the PCB along the outside edge thereof, then reflecting the part of the shock wave propagating from the top to the bottom of the PCB at the center of the PCB. Thus a single high-amplitude shock wave is divided into two lower amplitude shock waves which are separated by a short period of time. The separation time is proportional to the speed of the shock wave through the PCB, as well as the separation distance between the two narrowing neck portions 61 and 63 of the PCB. It will be understood that more or less narrowing neck portions can be formed on the PCB without departing from the spirit and scope of the invention.

With the above-described PCB configuration, the present invention is capable of reducing or managing shock on the PCB and any components mounted thereto via three different mechanisms. These mechanisms include damping, reflection and dispersion. As shown in FIG. 3 for example, the features or components of the third damping section 56 control or reduce the shock waves substantially by reflection thereof, with a small amount of dispersion. Likewise, the features or components of the second damping section 54 control or reduce the shock waves via damping, in the sense that the amplitude of the shock wave is reduced. Also, the narrowing neck features of the fourth damping section 57 control or reduce the shock waves by reflection and dispersion.

It will be understood that the present invention is not limited to the particular shape and configuration as shown and described, as the shape of the substrate or PCB can greatly vary as well as the size, configuration, and location of the damping members and the damping sections. One or more damping sections can be eliminated and more sections can be added depending on particular damping requirements as dictated by the machinery or device with which the PCB or substrate is associated, without departing from the spirit and scope of the invention.

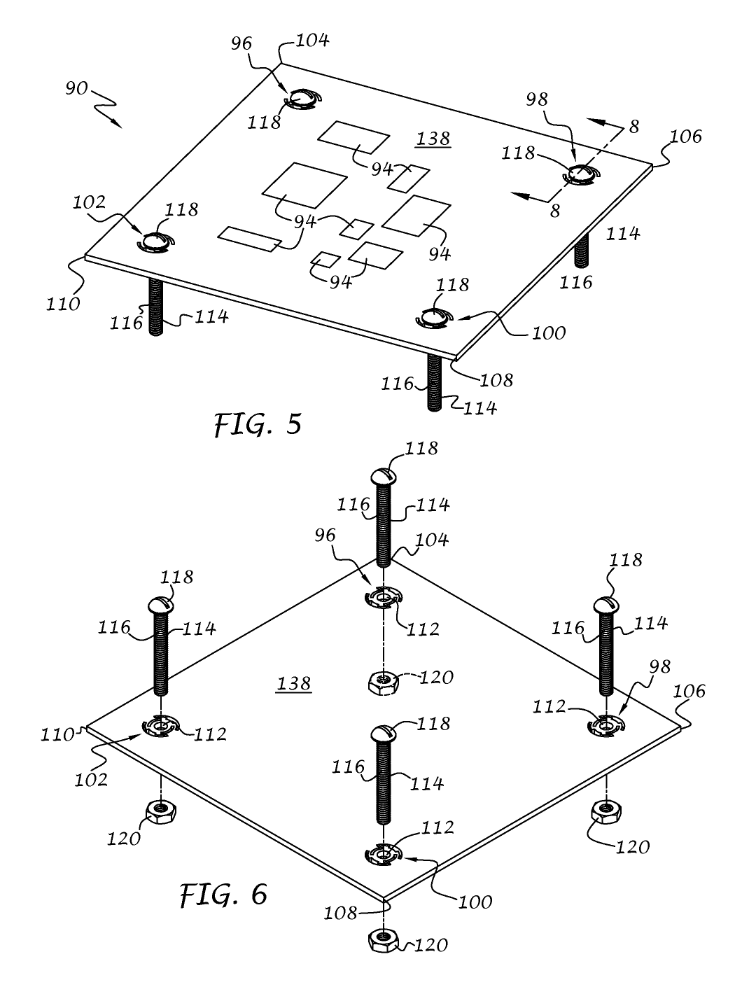

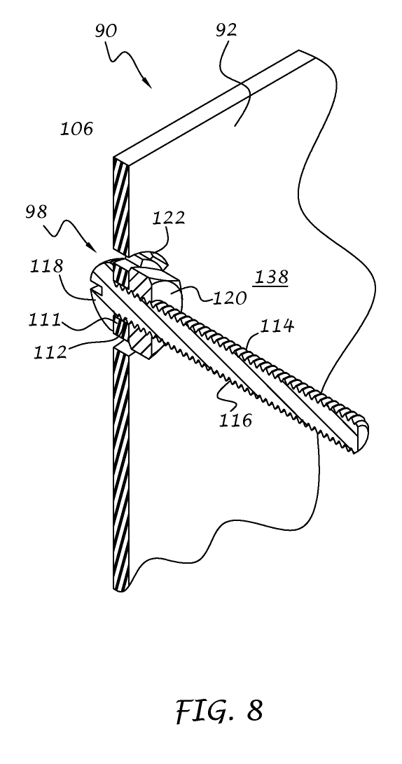

Referring now to FIGS. 5-8, an electronic assembly 90 with integral damping features in accordance with a further embodiment of the invention is illustrated. The electronic assembly 90 is configured to reduce the intensity of impacts and vibrations in a direction perpendicular to a plane of the substrate, but may also or alternatively be configured for reducing the intensity of lateral impacts and vibrations in directions parallel to the plane of the substrate or in any other direction as dictated by the particular machinery or device with which the electronic assembly 90 is associated.

The electronic assembly 90 preferably includes a generally square-shaped and relatively thin substrate 92, preferably configured as a PCB with conductive traces, ground planes, and so on located on a main body portion 138 of the substrate. As in the previous embodiment, the substrate can be formed of a variety of different materials or combinations thereof, and can be formed as a single layer or with multiple layers. Various electronic components 94 can be located on the main body portion 138 of the PCB or otherwise connected thereto and can include basic components such as surface-mount or thru-hole electronic devices such as, but not limited to, capacitors, resistors, inductors, transistors, relays, voltage regulators, and so on, as well as more advanced electronic components such as microprocessors, display drivers, displays, conventional and specialty chips, timers, and so on.

It will be understood that the invention is not limited to particular electronic components or circuitry as such components and circuitry can greatly vary depending on particular application specific devices. The invention does, however, reduce forces acting on the components due to acceleration, deceleration, sudden impact, as well as variable and steady vibrations and other movement that may generate forces that could otherwise negatively impact the integrity of the electronic assembly 90. To that end, damping sections 96, 98, 100, and 102 are positioned proximal to respective corners 104, 106, 108, and 110 of the substrate 92. Preferably, the damping sections also provide a mounting arrangement for connecting the substrate or PCB to devices, machines, or structures incorporating the electronic assembly 90.

The damping sections 96, 98, 100, and 102 are similar in construction and, for the purpose of brevity, only damping section 100 will be described, with like elements of each of the remaining damping sections being similarly labeled. The damping section 100 includes a connector area 111 integral with and partially separated from the main body portion 138, and includes a centrally located opening 112 extending therethrough for slidably receiving a spacer 114 (FIGS. 5, 6, and 8) for spacing and/or mounting the electronic assembly to further structure (not shown) associated with an apparatus, machine, or other device with electronics and/or electronic circuitry. The spacer 114 comprises a fastener with a threaded shank 116 that extends through the connector opening 112 and a head 118 that rests against the connector area 111 of the damping section 100. As shown, the diameter of the connector area 111 is approximately equal to the diameter of the head 118. However, it will be understood that the shape and/or diameter of the connector area 111 can greatly vary. A nut 120 or the like is threaded onto the shank 116 and tightened so that the connector area 111 of the damping section 100 is sandwiched between the head 118 and nut 120. The shank 116 can then be connected to further structure as previously described, with additional nuts, threaded apertures or other fastening means. It will be understood that washers or other suitable fastener components may be used between the head and connector area and/or the nut and the connector area It will be understood that the opening 112 can be threaded to eliminate the nut 120 or to enable a secure locking arrangement when the nut 120 is also used. It will be further understood that the spacer 114 can comprise other configurations such as a smooth shank or other shank shapes, other head shapes, and so on, without departing from the spirit and scope of the invention. It will be understood that the central opening can comprise a thru-hole in a PCB with spacers or fasteners being directly soldered thereto. The central opening may also be eliminated when surface-mount spacers or fasteners are suitable for the particular application.

Although four spacers/fasteners are shown, it will be understood that more or less spacers and/or fasteners can be provided at the same or different locations without departing from the spirit and scope of the invention. Moreover, it will be understood that the PCB can be of any suitable shape for a particular application, and thus is not limited to the square shape or to corners as shown and described.

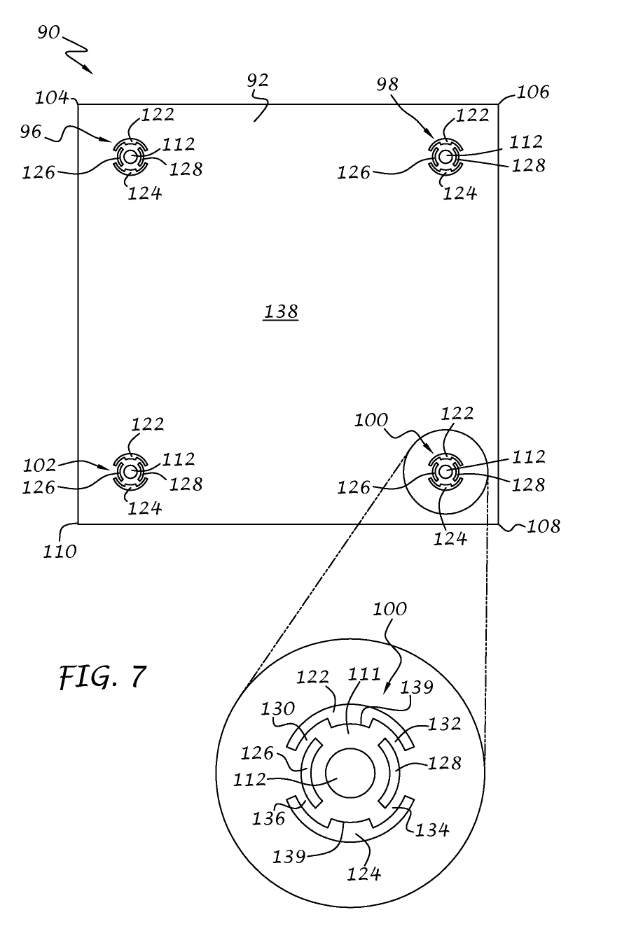

As best shown in FIG. 7, the damping section 100 also includes a pair of opposing outer arcuate slots 122, 124 centered around the opening 112 and a pair of opposing inner arcuate slots 126, 128 centered around the opening 112 and rotated approximately 90 degrees with respect to the outer pair of arcuate slots 122, 124 to form integral arcuate damping beams 130, 132, 134, and 136 that bridge the connector area 111 with the main body portion 138 of the substrate 92. As shown, the outer arcuate slots 122 include a depression 139 that limit the length of each beam.

In use, the damping beams 130, 132, 134, and 136 flex under applied forces transmitted through structure connected to the damping section 100 and the damping sections 96, 98, and 102 to thereby dampen the main body portion 138 and electronics and/or other components mounted thereto. The connector area 111 of each damping section will typically remain relatively static with respect to the structure on which it is mounted when the substrate or electronic assembly 90 is subjected to acceleration forces due to vibration, sudden impact, and so on. The integral nature of the damping beams 130, 132, 134, and 136 with the substrate 92 create an opposing biasing force when shock or vibration is transmitted perpendicular to the substrate 92, and may also accommodate shock or vibration transmitted in a plane parallel to the substrate 92.

It will be understood that the beams are not limited to the size and shape as shown, but are defined by the size, shape, and relative placement of the inner and outer pairs of slots, as well as the length and width of the depressions 139. Accordingly, the configuration and size of the beams can vary depending on the amount of damping in one or more directions that is required for a particular application.

It will be understood that the particular configuration of the damping sections is by way of example only and can vary by varying the number of slots, the relative location of slots, as well as their orientation, size, and shape, in accordance with the present invention. It will be further understood that more or less damping sections can be provided, and that the shape of the substrate or PCB can greatly vary.

Moreover, one or more damping sections of the previous embodiment shown in FIG. 3 for example can be combined with one or more damping sections of the substrate 92 of the present embodiment for damping the substrate along two or more axes, depending on particular damping requirements as dictated by the machinery or device with which the PCB or substrate is associated.

It will be understood, therefore, that the invention is not limited to the particular embodiments disclosed, but is intended to cover all modifications and variations within the spirit and scope of the present invention as defined by the appended claims.

It will be further understood that terms of orientation and/or position refer to relative, rather than absolute orientations and/or positions.

What is claimed is:

1. A transducer for determining the level of liquid within a container, the transducer comprising:
a mounting head adapted for connection to the container;
a sensor tube extending from the mounting head;
a substrate located in the sensor tube;
at least one sensor positioned on the substrate for sensing a level of liquid within the container; and
at least one damping section having at least one damping beam integrally formed with the substrate and partially separated therefrom by a slot formed between the at least one damping beam and the substrate, the at least one damping beam being normally in contact with a surface associated with the sensor tube and being movable toward and away from the substrate to thereby dampen forces acting on the transducer and thus on the at least one sensor.

2. A transducer according to claim 1, wherein the substrate comprises first and second longitudinal sides and further wherein the at least one damping section comprises:
a plurality of spaced first damping beams integrally formed with the substrate along the first longitudinal side and extending toward an inner surface of the sensor tube in a first direction; and
a plurality of spaced second damping beams integrally formed with the substrate along the second longitudinal side and extending toward the inner surface in a second direction opposite the first direction so that the first and second damping beams exert pressure in opposite directions on the inner surface to thereby center the substrate within the sensor tube and dampen lateral forces on the substrate as the first and second damping beams flex toward and away from their respective first and second longitudinal sides when the transducer is exposed to outside lateral forces.

3. A transducer according to claim 1, wherein the at least one damping section is located at one end of the substrate and adapted to contact a lateral surface associated with the sensor tube, the at least one damping section comprising:
a plurality of spaced damping beams integrally formed with the substrate via a first plurality of slots extending into the substrate from a first side thereof and a second plurality of slots extending into the substrate from a second side thereof, the first and second slots being offset to form the spaced damping beams with the beams being connected to each other in cantilever fashion via integral links that alternately extend between adjacent ends of the damping beams to thereby form a convoluted damping structure;
wherein the damping beams move toward and away from each other to respectively narrow and expand the slots when the transducer is exposed to outside longitudinal forces to thereby significantly dampen longitudinal forces acting on the substrate and thus the at least one sensor.

4. A transducer according to claim 1, wherein the at least one damping section comprises:
a first damping section having first beams integrally formed with the substrate and associated with longitudinal edges of the substrate to thereby dampen forces acting on the substrate in a lateral direction;
a second damping section having second beams integrally formed with the substrate and associated with a first lateral edge of the substrate, the second beams being connected to each other in cantilever fashion via integral links that alternately extend between adjacent ends of the damping beams to thereby form a convoluted damping structure resistant to forces acting in a longitudinal direction; and
a third damping section having third beams and substrate areas located between the third beams, each of the third beams and substrate areas being integrally formed with the substrate and partially separated therefrom by a plurality of slots extending in opposite directions such that the third beams and substrate areas are connected together and to the substrate in cantilever fashion; the substrate areas being larger than the third beams for receiving one or more electronic components to thereby dampen the electronic components when the transducer is subjected to longitudinal forces.

5. A transducer according to claim 1, and further comprising a float constrained to move along the sensor tube, the float including an actuator for changing an electrical state of the sensor to thereby indicate the level of liquid

6. An electronic assembly comprising:
a substrate for receiving at least one electronic component;
at least one damping section integrally formed with the substrate and including at least one slot formed in the substrate and at least one damping beam partially separated from the substrate by the at least one slot;
wherein the at least one damping beam is adapted to flex when the electronic assembly is exposed to outside forces to thereby dampen resultant forces acting on the substrate.

7. An electronic assembly according to claim 6, wherein the at least one damping section further comprises:
a connector area with a central opening for receiving a fastener for connecting the electronic assembly to structure; and
wherein the at least one slot comprises a first pair of opposing outer arcuate slots centered around the opening to thereby partially separate the connector area from a main body portion of the substrate.

8. An electronic assembly according to claim 7, and further comprising a pair of opposing inner arcuate slots centered around the opening and spaced from the outer arcuate slots.

9. An electronic assembly according to claim 8, wherein the inner and outer arcuate slots are rotated approximately 90 degrees to form integral arcuate damping beams that bridge the connector area with the main body portion of the substrate.

10. An electronic assembly according to claim 9, wherein the outer arcuate slots include a depression that limits a length of each beam.

11. An electronic assembly according to claim 9, wherein the beams are resilient in a direction perpendicular to the substrate to thereby dampen forces acting perpendicular to the substrate.

12. An electronic assembly according to claim 9, wherein the at least one damping section comprises at least first and second damping sections.

13. An electronic assembly according to claim 12, wherein the first and second damping sections are similar in construction.

14. An electronic assembly according to claim 9, and further comprising a fastener with a shaft extending through the central opening and a head resting against the connector area.

15. An electronic assembly according to claim 14, and further comprising a nut threaded onto the fastener and sandwiching the connector area between the head and the nut.

16. An electronic assembly according to claim 6, wherein the at least one damping section comprises:
a plurality of spaced first damping beams integrally formed with the substrate along a first side thereof and extending in a first direction; and
a plurality of spaced second damping beams integrally formed with the substrate along a second side thereof and extending in a second direction opposite the first direction so that the first and second damping beams exert pressure in opposite directions to thereby center the substrate and dampen lateral forces on the substrate as the first and second damping beams flex toward and away from their respective first and second sides when the electronic assembly is exposed to outside lateral forces.

17. An electronic assembly according to claim 6, wherein the at least one damping section is located at one end of the substrate and adapted to contact a lateral surface, the at least one damping section comprising:
a plurality of spaced damping beams integrally formed with the substrate via a first plurality of slots extending into the substrate from a first side thereof and a second plurality of slots extending into the substrate from a second side thereof, the first and second slots being offset to form the spaced damping beams with the beams being connected to each other in cantilever fashion via integral links that alternately extend between adjacent ends of the damping beams to thereby form a convoluted damping structure;
wherein the damping beams move toward and away from each other to respectively narrow and expand the slots when the electronic assembly is exposed to outside longitudinal forces to thereby significantly dampen longitudinal forces acting on the substrate.

18. A method of damping an electronic assembly comprising:
providing a substrate with at least one electrical property;
forming a slot in the substrate to define at least a portion of a damping beam integrally connected to the substrate;
exposing the electronic assembly to an outside force; and
flexing the damping beam toward and away from the substrate to thereby dampen a resultant force on the substrate.

19. A method according to claim 18, wherein the step of forming a slot comprises forming a plurality of slots to define at least a portion of a plurality of damping beams integrally formed with the substrate, each damping beam being capable of flexing when exposed to a sufficient amount of forces caused by vibration, sudden impact, acceleration, and deceleration.

20. A method according to claim 19, and further comprising forming a plurality of damping sections at spaced locations on the substrate with the plurality of slots and damping beams to thereby dampen the entire substrate from the forces.
